(19) United States
(12) Patent Application Publication
(10) Pub. No.: US 2026/0025181 A1
(43) Pub. Date: Jan. 22, 2026

(54) SYSTEM AND METHODS FOR ML-BASED SUB-BAND CHANNEL ESTIMATION, PREDICTION, AND EXTRAPOLATION

(71) Applicant: AIRA TECHNOLOGIES, INC., Saratoga, CA (US)

(72) Inventors: Ravikiran GOPALAN, Saratoga, CA (US); Gautham Hariharan, Sunnyvale, CA (US); Chandra Sekhar Tedla, Mountain View, CA (US); Arman Rahimzamani, San Jose, CA (US); Sandeep Kesireddy, San Jose, CA (US); Anand Chandrasekher, Saratoga, CA (US)

(21) Appl. No.: 19/268,980

(22) Filed: Jul. 14, 2025

Related U.S. Application Data
(60) Provisional application No. 63/672,373, filed on Jul. 17, 2024.

(51) Int. Cl. H04B 7/06; H04B 17/309; H04L 5/00; H04L 27/26; H04L 41/16

(52) U.S. Cl. CPC H04B 7/0626; H04B 17/346; H04L 5/0098; H04L 27/261; H04L 41/16

(57) ABSTRACT

This disclosure relates to methods, systems, and devices for AI/ML assisted wireless channel fingerprinting, estimation, and prediction. In one example embodiment, a method of combined AI/ML assisted wireless channel fingerprinting and channel prediction is disclosed. The method includes using a trained neural network to fingerprint the channel with the channel fingerprinting results advantageously being leveraged for channel extrapolation and to improve the channel prediction across time and frequency.

### CROSS-REFERENCE TO RELATED APPLICATION

This application claims the benefit of priority under 35 U.S.C. § 119(e) to U.S. Provisional Patent Application No. 63/672,373, entitled “SYSTEM AND METHODS FOR ML-BASED SUB-BAND CHANNEL ESTIMATION, PREDICTION, AND EXTRAPOLATION,” filed on Jul. 17, 2024, the entirety of which is incorporated herein by reference.

### BACKGROUND

Accurate channel estimation is essential for modern radio communication systems, especially in highly dynamic and time-varying environments. Multiple communication functions (beamforming, scheduling, resource allocation, etc.) depend highly on accurate channel estimation. In wireless communication systems, the channel between the transmitter and receiver is often characterized by a time-varying, multipath channel. Multipath channel characteristics can vary rapidly due to factors such as mobility and environmental changes.

A channel estimation technique that can accurately estimate and predict the channel response and parameters, and obtain reliable information about the channel's characteristics would greatly improve the performance of the wireless network. Improving channel estimation can benefit all downstream tasks, eventually improving key performance indicators (KPIs) for customers and network operators. In addition, accurate channel estimates can be used to improve various communications functions such as beamforming, scheduling, and resource allocation. Improving these functions can lead to better quality of service (QOS), higher throughput, and lower packet loss rates. Accurate channel prediction can also improve the QoS and overall performance (e.g., throughput, delay, etc.) of the wireless system by providing information about future channel conditions.

### SUMMARY

In accordance with one or more embodiments, various features and functionalities are provided to enable AI/ML assisted wireless channel fingerprinting and wireless channel estimation and prediction by leveraging a trained neural network capable of tracking and predicting the underlying channel variations despite the limited sampling.

In general, one aspect of the disclosed features includes a system, comprising one or more hardware processors; and one or more non-transitory machine-readable storage media encoded with instructions that, when executed by the one or more hardware processors, cause the system to perform operations comprising: receiving a first signal from a user equipment (UE) at a first slot; analyzing the first signal to estimate channel state information (CSI) of a first frequency sub-band at the first slot; receiving a second signal from the UE at a second slot; analyzing the second signal to estimate CSI of a second frequency sub-band; and generating, using a machine learning (ML) model, extrapolated CSI of the first frequency sub-band at the second slot based on the estimated CSI of the first frequency sub-band at the first slot and the estimated CSI of the second frequency sub-band at the second slot.

Embodiments of the system may include one or more of the following features. In some embodiments, the signal from the UE may be at least one of a pilot signal, training sequence, reference signal, sounding reference signal (SRS), and uplink demodulation reference signal (DMRS). In some embodiments, the CSI of a frequency sub-band may include properties of a channel on the frequency sub-band. Properties of a channel may include signal-to-noise-ratio (SNR), signal-to-interference-plus-noise-ratio (SINR), Doppler spread, and delay spread.

In some embodiments, the second slot is at a time after the first slot. In some embodiments, the time period over which the SRS signal is transmitted may be 20 milliseconds (ms), but other periodicities are possible too. In some embodiments, the second frequency sub-band is adjacent to the first frequency sub-band. In some embodiments, the ML model is trained with set ranges of CSI of frequency sub-bands across time and frequency. The ML model may be trained to extrapolate CSI of a plurality of frequency sub-bands at a plurality of slots according to estimated CSI determined from signals received from the UE.

In some embodiments, the operations further comprise: receiving a third signal from the UE; analyzing the third signal to estimate the CSI of the first frequency sub-band at the second slot; and training the ML model with the extrapolated CSI and the estimated CSI of the first frequency sub-band at the second slot. In some embodiments, the operations further comprise: transmitting, via beamforming and using a multiple-input multiple-output (MIMO) technique, a transmission signal to the UE based on the extrapolated CSI of the first frequency sub-band at the second slot.

Other features and aspects of the disclosed technology will become apparent from the following detailed description, taken in conjunction with the accompanying drawings, which illustrate by way of example, the features in accordance with embodiments of the disclosed technology. The summary is not intended to limit the scope of any inventions described herein, which are solely defined by the claims attached hereto.

### BRIEF DESCRIPTION OF THE DRAWINGS

The technology disclosed herein, in accordance with one or more various embodiments, is described in detail with reference to the following figures (hereafter referred to as “FIG.”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is an example illustration of channel estimation at low Doppler, according to one embodiment of the disclosed technology.

FIG. 2 is an example illustration of channel estimation at medium to high Doppler, according to one embodiment of the disclosed technology.

FIG. 3 is an example illustration of sounding reference signals (SRS) from multiple user equipment (UEs), according to one embodiment of the disclosed technology.

FIG. 4 is an example illustration of downlink (DL) signal-to-interference-plus-noise-ratio (SINR) with channel aging, according to one embodiment of the disclosed technology.

FIG. 5 is an example illustration of DL SINR with channel aging, according to one embodiment of the disclosed technology.

FIG. 6 is an example illustration of channel extrapolation, according to one embodiment of the disclosed technology.

FIG. 7 is an example illustration of DL SINR with beamforming from channel extrapolation, according to one embodiment of the disclosed technology.

FIG. 8 is an example illustration of channel extrapolation across time and frequency, according to one embodiment of the disclosed technology.

FIG. 9 is an example illustration of DL SINR with channel extrapolation across time and frequency, according to one embodiment of the disclosed technology.

FIG. 10A is a block diagram of an example process of training one or more of the AI/ML models disclosed herein, according to one embodiment.

FIG. 10B is a block diagram of an example process of testing one or more of the AI/ML models disclosed herein, according to one embodiment.

FIG. 11 is an illustration of an example method for ML-based sub-band channel extrapolation, according to one embodiment.

FIG. 12 illustrates an example computing system that may be used in implementing various features of embodiments of the disclosed technology.

### DETAILED DESCRIPTION

Accurate knowledge of the wireless channel at the transmitter (gNB or base station) is a key requirement for effective beamforming in the downlink (DL) to achieve high spectral efficiency in wireless communication systems. This is critical for massive MIMO deployments that enable multi-user (MU) communication in the downlink, where the beamforming algorithm also needs to null the interference to other users. A major challenge in maintaining accurate channel state information (CSI) is channel aging, i.e., the degradation of CSI quality due to the time-varying channel. Both environmental changes, as well as relative mobility between the gNB and the users (UEs), contribute to channel aging. This is a critical problem for existing 5G-NR & Next-Generation (NG) cellular deployments.

Pilot-aided channel estimation (as opposed to blind estimation) is typically performed by transmitting a known signal from the transmitter to the receiver. Examples of known signals used for channel estimation include but are not limited to pilot signals, training sequences, reference signals, and sounding reference signals (SRS). For time division duplex (TDD) systems (where the same frequency band and the same set of subcarriers are used for both downlink and uplink transmissions) it is possible to estimate the channel in the uplink direction at the base station, and beamform in the downlink direction by transmitting the SRS in the uplink in a special slot scheduled by the base station. The special slot can be scheduled both aperiodically and periodically (e.g., for example, every 10 slots or alternatively every 5 slots, etc.).

In reciprocal channels (i.e., the channel response is expected to be identical in both the uplink and downlink direction, not taking into account the radio effects, which can be calibrated out), it is possible to estimate the channel in the uplink direction at the base station and use the estimate in the downlink direction (or vice-versa). The SRS is transmitted in a special slot [S] that is scheduled by the base station. The user equipment (UE) sends the SRS signals to the base station in the [S] slot using a predetermined set of parameters (e.g., the frequency and time-domain location of the signal). The base station is configured to receive the SRS signal and use it to estimate the channel characteristics (e.g., channel frequency response, channel delay spread, and Doppler).

The multipath fading channel between the transmitter and receiver (a communication channel exists between each transmit/receive antenna pair) is often modeled as a linear time-varying system with an equivalent baseband equivalent of the form, as is well known in the art:

$$y ( t ) = {\sum }_{i} {a}_{i} ( t ) x ( t - {τ}_{i} ( t ) ) + z ( t )$$

where y(t) is the received signal, x(t) is the transmitted signal, z(t) is additive white Gaussian noise, i is the number of resolvable paths from the transmitter to the receiver, aᵢ(t) is the overall attenuation of path i, and τᵢ(t) is the propagation delay from the transmitter to the receiver of path i. The equivalent baseband model determines the channel's behavior and characteristics across frequency and time. The channel characteristics typically include at least one of: (i) delay spread; (ii) coherence bandwidth (inversely proportional to delay spread); (iii) Doppler; (iv) coherence time (inversely proportional to Doppler) and (v) channel model (e.g., pedestrian, indoor, vehicular, etc.). The communication channel also typically includes dynamic user characteristics that also affect the channel's behavior. The user characteristics typically include at least one of: (i) path loss (determined by the distance from a next generation node B (gNodeB or gNB)); (ii) user mobility; and (iii) other radio frequency (RF) impairments.

Current channel estimation methods implemented in 5G systems fail to use side information that could be extracted from RF and user characteristics. For example, conventional channel estimation schemes often fail to use delay spread and Doppler information. Unlike the current methods, the disclosed artificial intelligence (AI) assisted wireless channel prediction and estimation system (hereafter referred to as the “system”) can use information between adjacent frames and prior frames in a two-dimensional image representation (TDIR) to improve channel estimation and prediction. The system can accurately predict the complex channel response (consisting of a real and imaginary component) when no reference signal is present for each subcarrier and slot. For example, given a SRS is sent only once every 10 slots (e.g., a periodicity of one SRS signal every 10 milliseconds), the system can accurately predict the channel estimate for non-SRS slots.

In one embodiment, the system includes an AI or machine learning (ML) model trained to generate a channel estimate and prediction from channel state information (CSI) obtained from a SRS received from the UE. For example, upon receiving an SRS from a UE at a first slot, the estimated CSI of a frequency sub-band at the first slot may be determined. The AI/ML model may be trained with true CSI (where genie data is available for example from simulation) of frequency sub-bands that are determined from SRS received from the UE at various slots to extrapolate and predict channels for closely based, adjacent frequency sub-bands at various slots, where CSI of such adjacent frequency sub-bands at the various slots is currently unknown. The AI/ML model may be retrained with additional CSI of frequency sub-bands as additional SRS are received from the UE, improving the channel estimation and KPIs related to demodulation performance.

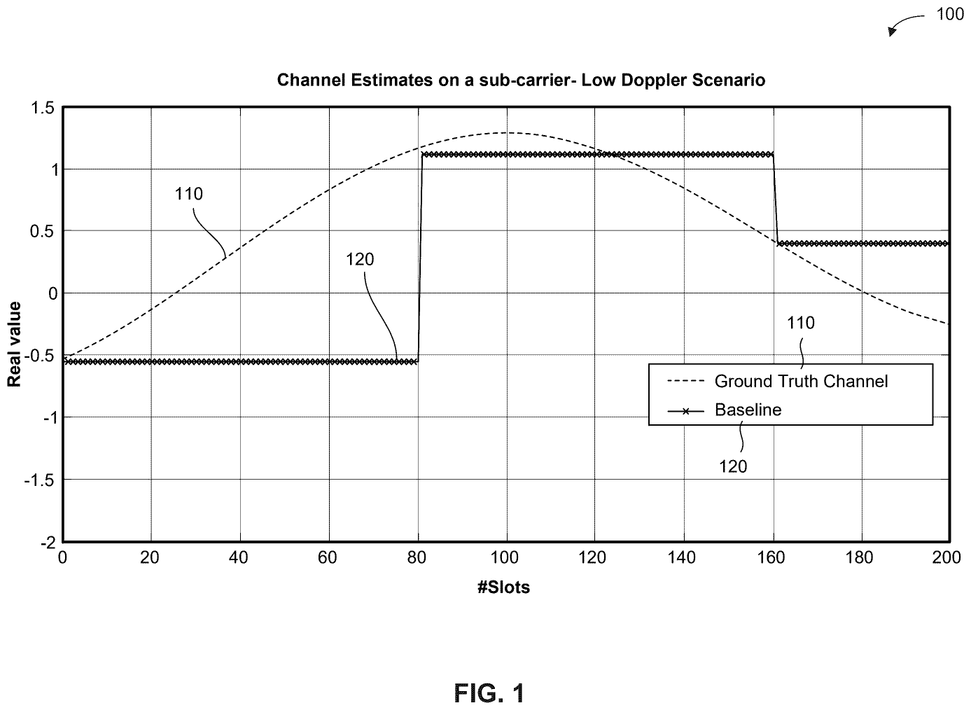

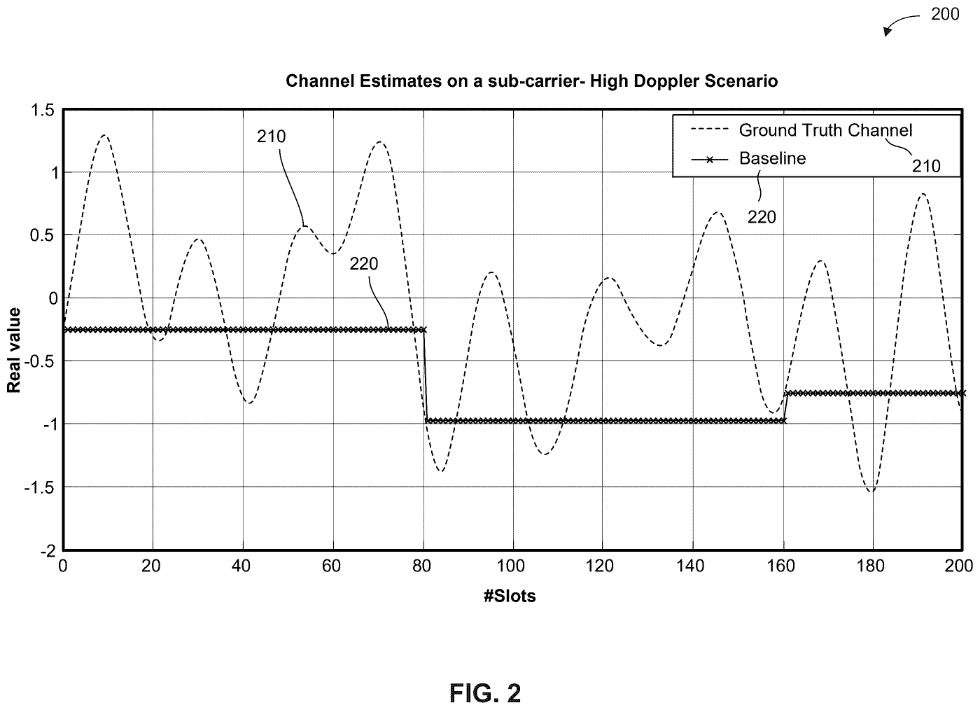

FIGS. 1 and 2 illustrate examples of channel estimations at various Doppler scenarios. Channel aging may be especially problematic in mobile environments with high Doppler frequencies where the channel varies rapidly across time which often results in increased channel estimation error. Channel prediction combats channel aging by predicting the channel estimate for future slots. In addition, if the delay spread of the communication channel is large and the channel coherence bandwidth is small then the variation of the channel's response across the frequency bandwidth (i.e., subcarriers) may be large. A resource block that contains only a single SRS for all subcarriers in that resource block may experience degraded performance due to increased channel estimation error for subcarriers that are further away from the subcarrier that transmits the underlying reference signal.

Sending known reference signals and using such reference signals to estimate the channel coefficients may be used to obtain accurate channel state information (CSI). However, this process requires precious spectral resources that may otherwise be used for sending data. Therefore, reference signals may typically be sent sparsely in time in wireless systems. For example, while 3GPP's 5G-NR specifications may allow a sounding reference signal (SRS) of a user equipment (UE) to be sent as often as 2.5 milliseconds (every 5 time division duplex (TDD) slots with a subcarrier spacing of 30 KHz), existing deployments may typically configure SRS to be sent from a UE to a base station (gNB) every 20 or 40 milliseconds, for example.

Most existing deployments may include channel estimation schemes that estimate the channel in the SRS time slot, and then may reuse/hold this value between SRS slots. This causes a non-trivial divergence between estimated channel response, i.e., baseline 120, and true channel realization, i.e., ground truth channel 110, even for stationary scenarios or under very low Doppler as shown in FIG. 1. FIG. 2 shows even more significant deviations between the estimated channel response, i.e., baseline 220, and the true channel realization, i.e., ground truth channel 210, in medium to high Doppler scenarios.

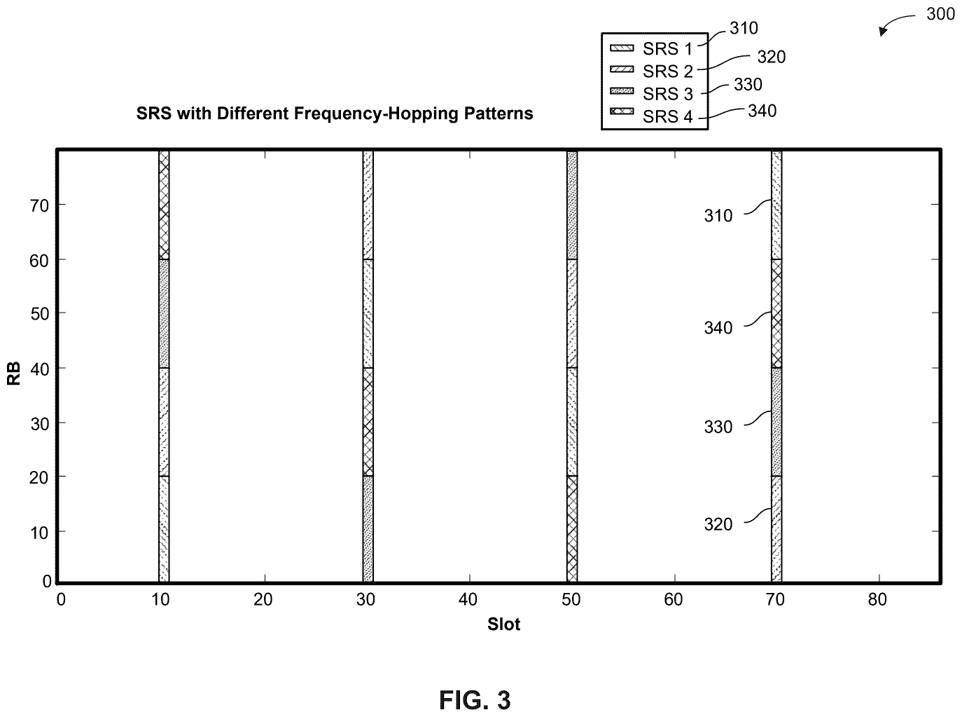

FIG. 3 illustrates an example of sounding reference signals (SRS) from multiple user equipment (UEs). In addition to the sparsity of receiving reference signals in time from UEs, reference signals may also typically be sent sparsely in the frequency domain. The 3GPP specifications may allow for SRS to be configured on a sub-band basis, and 5G-NR multiple-input multiple-output (MIMO) deployments may leverage this configuration to schedule multiple UEs to send SRS within a slot, having each UE only send SRS on a subset of the bandwidth. This may also facilitate UEs to reliably send SRS from farther distances to the gNB or base station by focusing the transmit (Tx) power over only a smaller group of subcarriers, as shown in FIG. 3. For a set of 4 UEs that may be frequency multiplexed in a slot with an SRS period of for example 20 milliseconds, it may take 80 milliseconds with frequency hopping to obtain CSI across the full bandwidth. For example, a first UE sending SRS1 310 may obtain CSI for the sub-band covered by resource blocks 0-19 in the first 10 milliseconds slot, obtain CSI for the sub-band covered by resource blocks 40-59 in the 30 milliseconds slot, obtain CSI for the sub-band covered by resource blocks 20-39 in the 50 milliseconds slot, and obtain CSI for the sub-band covered by resource blocks 60-79 in the 70 milliseconds slot. In an 80 millisecond period, the first UE sending SRS1 310 may obtain CSI across the full 80 MHz bandwidth. For reference, with even 30 Hz Doppler, the channel coherence time may be on the order of 15-20 milliseconds which may imply that the channel de-correlates much faster than the 80 millisecond period over which updated CSI is guaranteed across the full bandwidth.

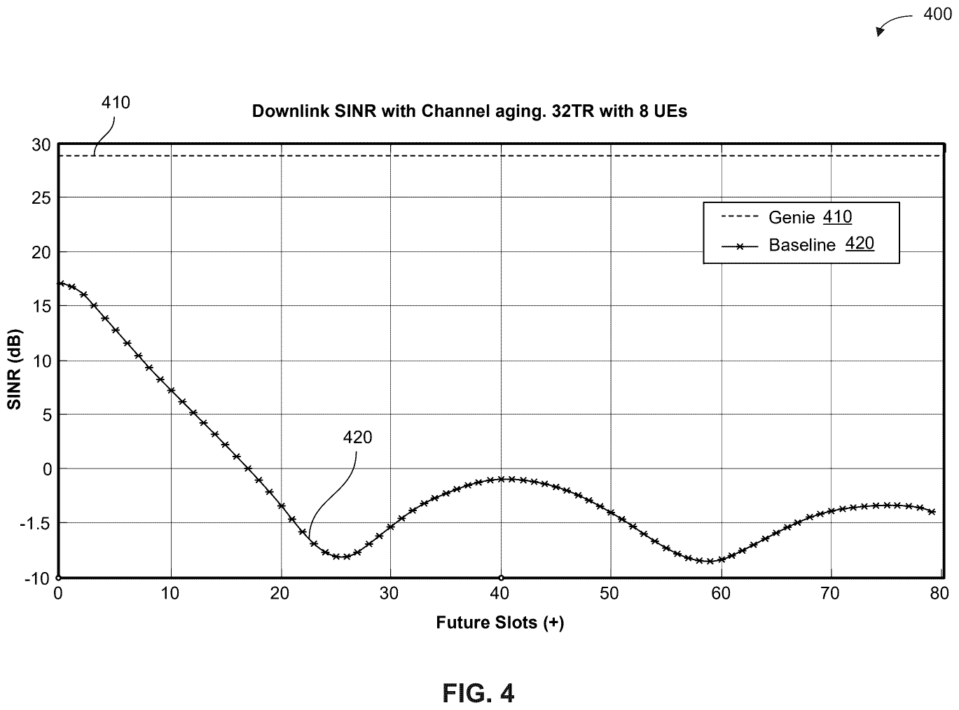

FIG. 4 illustrates an example of downlink (DL) signal-to-interference-plus-noise-ratio (SINR) with channel aging. Due to the sparse time-frequency structure of reference signals, the gNB may only have access to stale and unreliable CSI, particularly with large numbers of UEs and with mobility. This may be particularly problematic with SRS since CSI is used to schedule UEs in the DL in TDD systems, that may exploit channel reciprocity. A range of DL configuration parameters, including the number of layers, modulation and coding schemes (MCS), and beamforming weights, may be calculated based on CSI on a per-slot basis. FIG. 4 shows the impact of sub-optimal CSI on DL signal-to-interference-plus-noise-ratio (SINR) for a UE in multiple user MIMO (MU-MIMO), where the baseline scheme just estimates the channel at time=0 and holds or reuses the value for all future time slots. The plot of FIG. 4 illustrates the large gap between achievable performance under perfect CSI, genie 410, and the realization in currently deployed O-RAN systems, baseline 420.

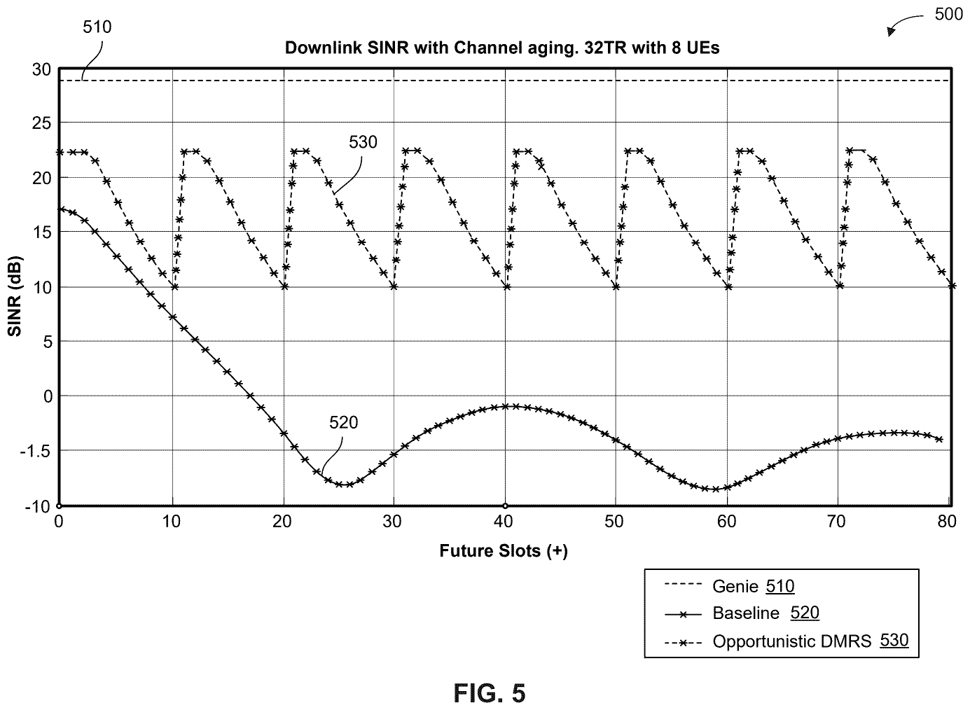

FIG. 5 illustrates an example of DL SINR with channel aging using opportunistic uplink demodulation reference signal (DMRS). An additional reference signal known as DMRS may be used to estimate the uplink channel just before demodulation at the gNB. The DMRS is a reference signal that can be used in both the downlink and uplink transmission for channel estimation and equalization during demodulation and decoding. In downlink and uplink transmission, the DMRS may be transmitted in the same resource block (RB) as data on the physical downlink shared channel (PDSCH) and physical uplink shared channel (PUSCH). The uplink DMRS may occupy one or more symbols of uplink slots in which PUSCH data is transmitted.

DMRS may be repurposed/reused to augment the CSI based on SRS for better tracking of time-varying channels on the DL. FIG. 5 illustrates the extent of improvements that may be feasible with this opportunistic DMRS approach, showing an optimistic scenario of improvements in DL SINR, represented by opportunistic DMRS 530, by refining CSI using DMRS on the slots in addition to the CSI baseline 520 from SRS. The slot pattern used in FIG. 5 is DDDSUUDDDD and 2 uplink slots occur every 10 slots, whereas SRS may be only sent every 80 slots. Due to the circular nature of the slot pattern, a shift in time for the same relative position of the S and U slots is immaterial, e.g., DDDDDDDSUU is the same pattern with a different “starting point.”

While FIG. 5 illustrates a case where DMRS is available on all uplink slots, this may not always be the case. With DMRS being tied to PUSCH, it may not be guaranteed that DMRS is on every uplink slot, and instead DMRS may only be sparsely available in time depending on PUSCH scheduling for the UE. With DMRS also being tied to the resource blocks (RBs) allocated for PUSCH in frequency, DMRS may be more frequently available in time, but not enough to cover all the RBs of an entire system bandwidth.

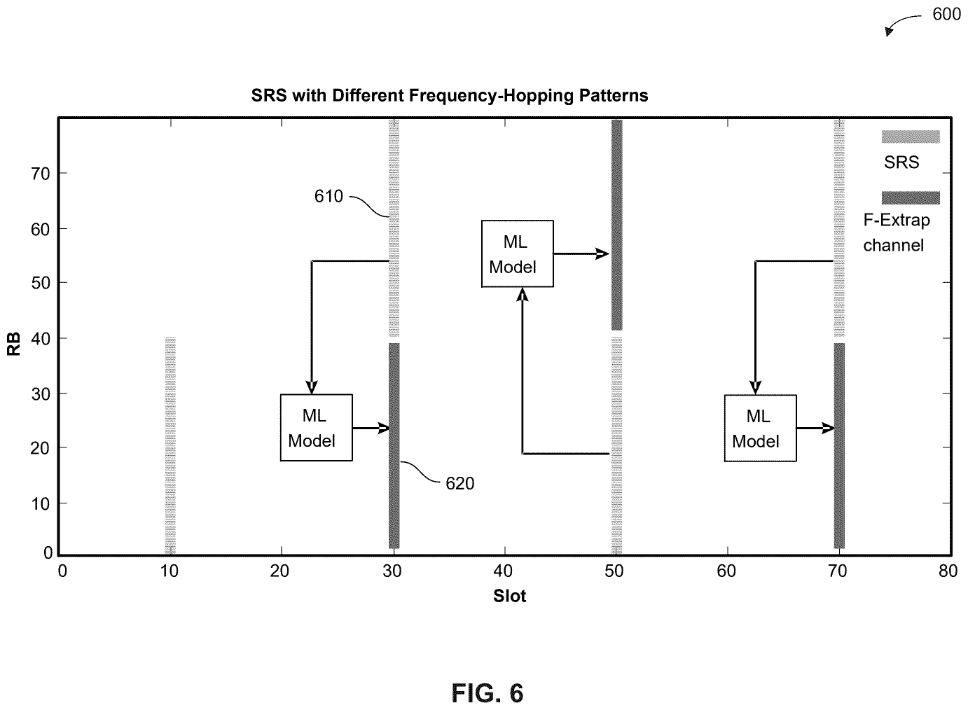

FIG. 6 illustrates an example of channel extrapolation. With SRS and DMRS both being sparsely available in the frequency domain and only typically available on a subset of RBs (or sub-bands) of the full bandwidth for a specific UE, channel extrapolation in frequency may be used to obtain accurate CSI. The large-scale propagation environment that influences the channel between the gNB and a UE, such as buildings, trees, and other objects that may influence scattering, may be similar between closely spaced frequency bands, including adjacent frequency bands. Hence the wireless channel on a sub-band may be learned or extrapolated from CSI of a closely spaced, adjacent sub-band.

The disclosed AI/ML model may be used to extrapolate and predict the channel response across frequency in an RB based on both the SRS and opportunistically DMRS. As shown in FIG. 6, an SRS from a UE may be received in a particular slot, such as the 30 millisecond slot, with the SRS being used to obtain CSI 610 for the 30 millisecond slot. Channel estimation algorithms use the SRS to obtain the CSI 610 in the frequency sub-band covered by resource blocks 40-79 in the 30 millisecond slot. Taking into account the frequency correlation between adjacent sub-bands, an AI/ML model may use the CSI 610 to estimate or extrapolate CSI 620 at an adjacent sub-band covered by resource blocks 0-39 in the 30 millisecond slot. Additionally, by taking into account the opportunistic DMRS when the UE transmits the PUSCH, the estimated CSI based on the DMRS may be updated, and the corresponding channel estimate provided by the AI/ML model may use the updated aperiodic opportunistic DMRS-based CSI. By taking into account the frequency correlation between adjacent sub-bands, the methods disclosed herein provide more accurate channel estimation and improve the overall performance of the wireless communication system.

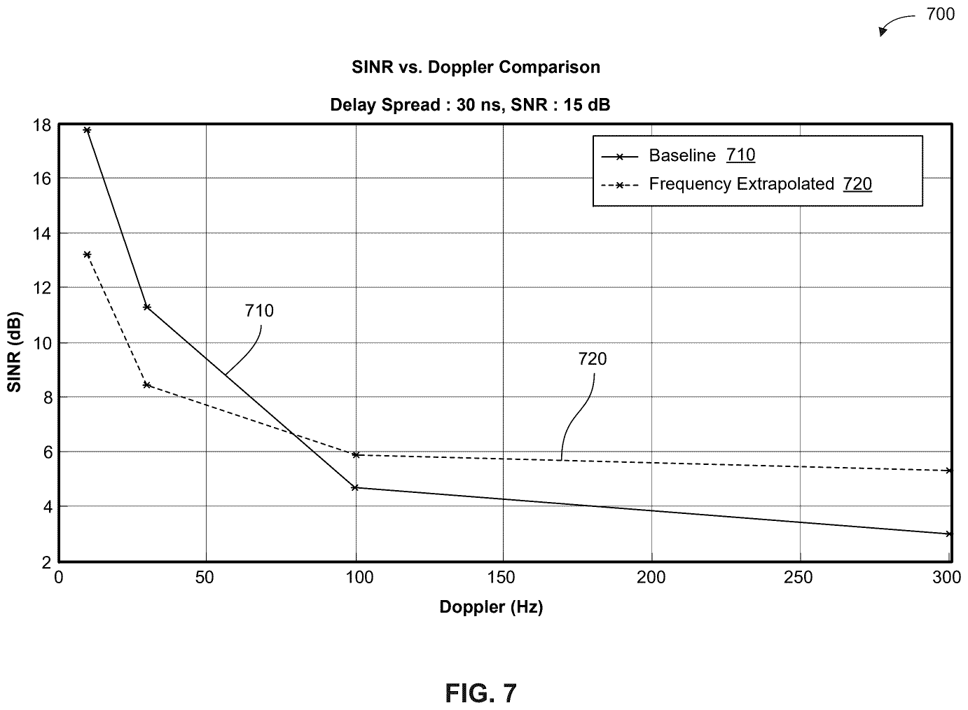

FIG. 7 illustrates an example of DL SINR with beamforming from channel extrapolation. Using the true CSI of a sub-band from an SRS with the frequency correlation between adjacent sub-bands in a given slot, non-trivial improvements are obtained with channel aging, in particular at higher Doppler frequencies. As shown in FIG. 7, DL SINR with beamforming is compared between channel estimation based only on SRS reference signals, baseline 710, and channel estimation based on reference signals on sub-bands with additional opportunistic DMRS reference signals with the addition of frequency extrapolation on sub-bands, frequency extrapolated 720.

Baseline 710 may present the most recently estimated value across time slots for subcarriers where no new SRS input is available. For low Doppler frequencies with slow channel aging, it may be better to hold the CSI from prior slots than dropping such CSI altogether and instead generating a frequency extrapolated value. Thus, it may be possible to further improve CSI quality by extrapolating CSI in both time and frequency dimensions.

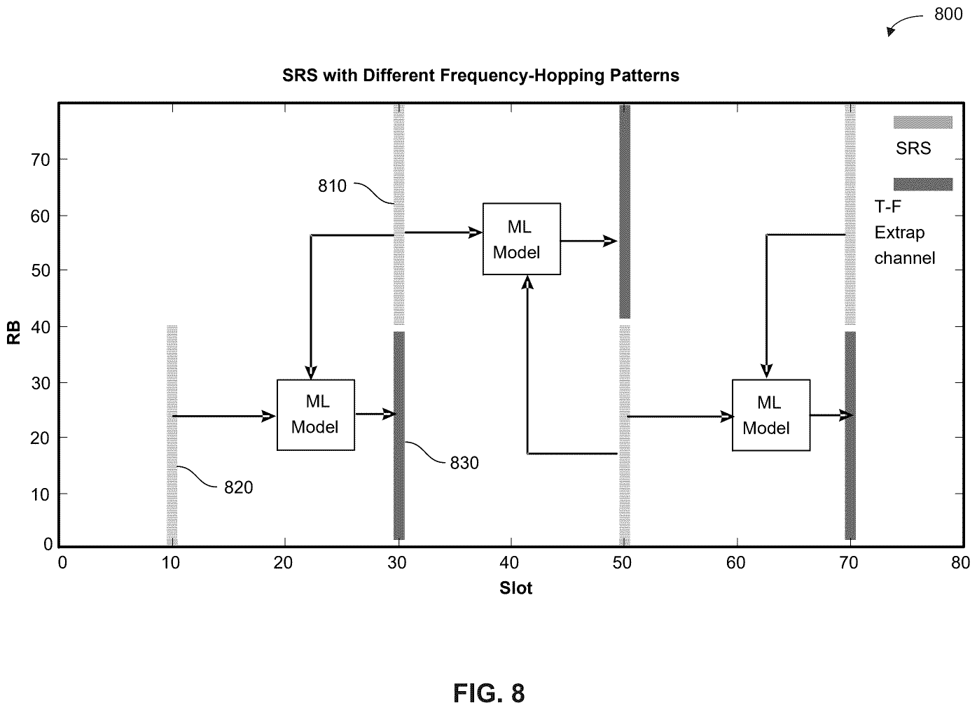

FIG. 8 illustrates an example of channel extrapolation across time and frequency. Wireless channel extrapolation in time may also be referred to as wireless channel prediction. The disclosed AI/ML model may be used to extrapolate and predict the channel response for each sub-band in a resource block across both frequency and time. An example of frequency correlation is shown in FIG. 6. As described in FIG. 6, the underlying channel realization, CSI 610, may be used by the AI/ML model to estimate the channel response, CSI 620, from the SRS signal received from a UE for a given slot of 30 millisecond for all resource blocks based on frequency extrapolation on sub-bands. Expanding on the frequency extrapolation described in FIG. 6, FIG. 8 provides a solution for improving and predicting CSI across both frequency and time. As shown in FIG. 8, the CSI from a prior slot, such as CSI 820 in the 10 millisecond slot, may be used by the AI/ML model along with the underlying channel realization, CSI 810, to obtain an improved and more accurate extrapolation and prediction of the estimated channel response, CSI 830, at the 30 millisecond slot. This takes into account the frequency correlation between sub-bands at the same slots and the time correlation between channels at the same sub-bands for different slots.

To accomplish the improved method in FIG. 8, an SRS may need to be accurately “fingerprinted” to obtain channel dynamics or properties, such as CSI 810, of the frequency sub-band. Channel properties may include one or more of signal-to-noise-ratio (SNR), signal-to-interference-plus-noise-ratio (SINR), Doppler spread, and delay spread per UE-gNB link. The channel properties are binned across suitable ranges of SNR, SINR, delay, and Doppler. Multiple AI/ML models may be trained according to various combinations of the binned channel properties. The multiple AI/ML models may be trained with CSI stored in databases, simulated using a mathematical model, and/or previously obtained from SRS at various slots and sub-bands. The datasets of CSI used to train the multiple AI/ML models may be binned instead of being across a wide range of channel dynamics, to reduce the effects of errors. In this way, each of the multiple AI/ML models may be trained according to different characteristics of the channel, e.g., low SNR, medium SNR, high SNR, no Doppler, low Doppler, medium Doppler, high Doppler, low delay spread, medium delay spread, high delay spread, etc., and a particular AI/ML model may be selected during deployment that is appropriately suited for extrapolation and tracking of a channel according to the values of the estimated CSI of a presently received signal from a UE.

For example, the multiple AI/ML models may be used for channel tracking by making estimations and extrapolations of CSI across time and frequency according to the channel properties, CSI 810 and CSI 820, the binned training datasets, and the frequency and time correlations to generate an extrapolated CSI 830. The channel properties, CSI 810 and CSI 820, may have particular values of SNR, SINR, Doppler, and delay according to the link between the gNB and a particular UE. According to the values of channel properties of CSI 810 and CSI 820, one of the multiple AI/ML models may be selected that was trained with binned training datasets of CSI similar to, or the same as, the values of CSI 810 and CSI 820. The selected AI/ML model may be appropriately suited for extrapolation and tracking of channels for the UE since it was trained with similar channel characteristics. The selected AI/ML model may be updated and retrained according to the CSI of sub-bands estimated from signals further received from the UE and/or true CSI (where genic data is available, for example from simulation) that becomes known.

In some embodiments, the selection of a suitable AI/ML model may be based on the channel properties derived from multiple CSI inputs, including CSI values corresponding to different frequency sub-bands and different time slots. For example, the channel properties may be determined jointly based on CSI 810 (from a first frequency sub-band at a first time slot) and CSI 820 (from a second frequency sub-band at a second time slot), or from any combination of temporally and spectrally distinct CSI estimates. By jointly analyzing the channel properties of these multiple CSI inputs, such as SNR, SINR, Doppler, and delay spread, the system may obtain a more robust profile of the current channel condition. These composite channel properties may then be used to select, from among the plurality of trained AI/ML models, the model whose training data corresponds to similar binned ranges of SNR, SINR, Doppler, and delay.

In some embodiments, the AI/ML model may receive CSI inputs from multiple prior time slots for the same frequency sub-band to enhance temporal context during channel extrapolation and prediction. Rather than relying on CSI from only a single previous slot, the model may integrate a sequence of CSI values from several past slots—e.g., the last 2, 3, or more time intervals—where each CSI is associated with the same sub-band but measured at different time indices. These multiple temporal inputs may be processed either through weighted aggregation, where more recent slots are given higher influence, or through a temporal encoding mechanism, such as a recurrent neural network (e.g., GRU, LSTM) or a temporal transformer, to learn long-range dependencies in channel evolution.

This multi-slot temporal integration approach may offer advantages over embodiments that rely on only a single prior CSI observation in some use cases. In scenarios with moderate to high mobility or rapid channel fluctuations, incorporating a history of recent CSI values allows the model to better learn the trajectory and rate of change of the channel over time, thereby producing a more accurate forecast of the current or future channel state. Additionally, when noise or estimation error affects an individual CSI observation, averaging across multiple temporally weighted inputs can smooth out transient anomalies and increase robustness. In other words, this approach may outperform the single-slot extrapolation method in environments with non-linear or bursty channel variation, such as in vehicular or drone-based wireless deployments.

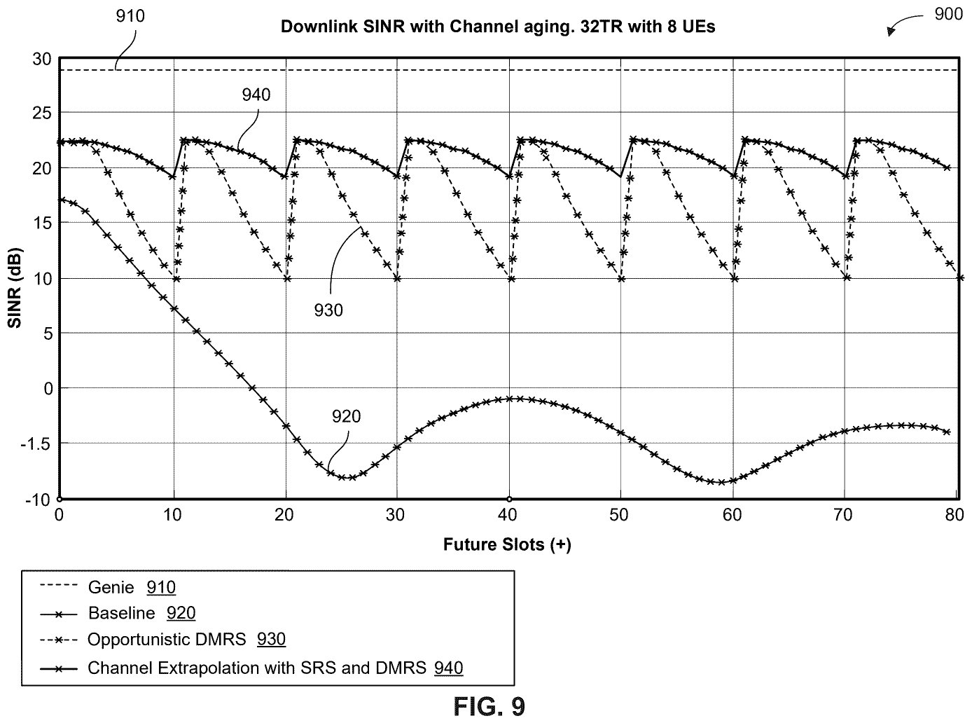

FIG. 9 illustrates an example of DL SINR with channel extrapolation across time and frequency. Using the improved channel extrapolation approach described in FIG. 8, significant improvements may be shown in channel tracking. FIG. 9 shows such improvements in channel tracking using the channel extrapolation approach across time and frequency, where the best performance in DL SINR is shown by the channel extrapolation line 940 where the values of channel extrapolation line 940 are greater than the channel realization of baseline line 920 and the opportunistic DMRS 930, and closest to the perfect CSI of genie 910.

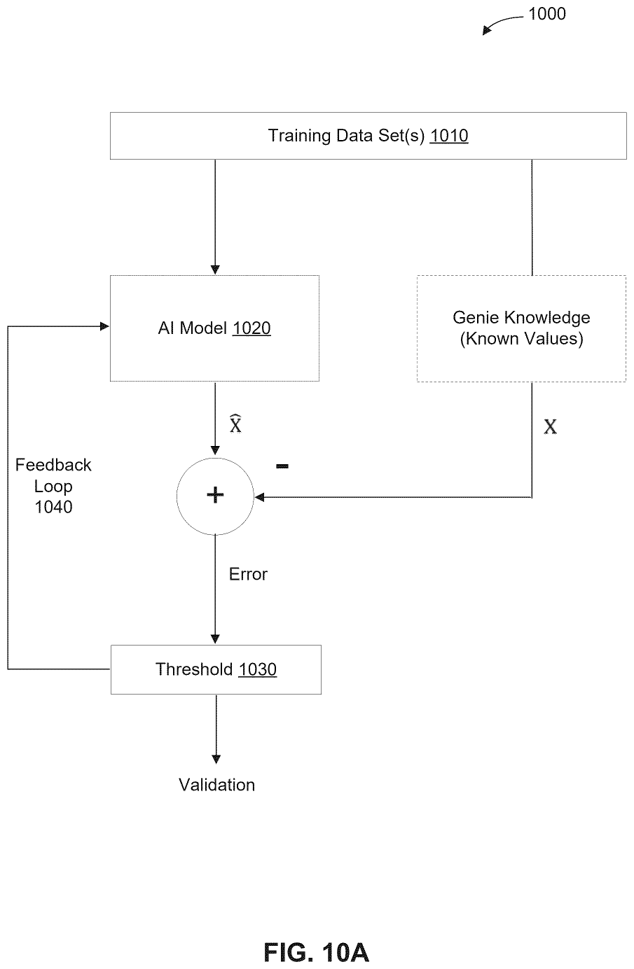

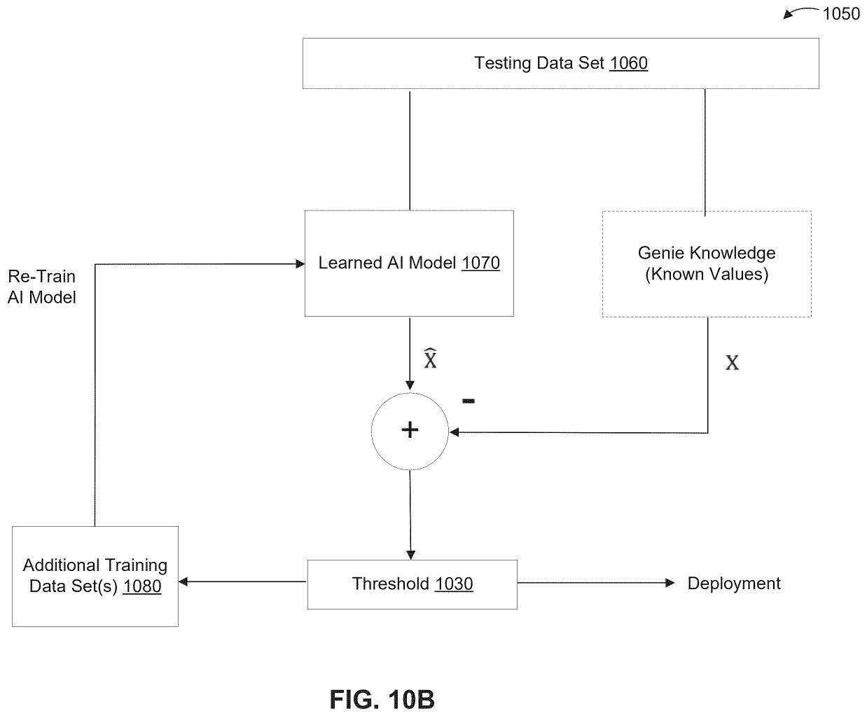

FIG. 10A is a block diagram of an example process 1000 of training the AI/ML models disclosed herein, according to one embodiment. The AI/ML models 1020 may include a CSI AI/ML model. Training of the AI/ML models 1020 can be performed wholly on the system, or in part, e.g., with a remote/cloud infrastructure. Training each AI/ML model 1020 includes inputting one or more training data sets 1010 into the AI/ML model 1020. For example, training data of various types of wireless signals, CSI, frequency sub-bands, and slots may be used as inputs to train the AI/ML model 1020. Examples of training data 1010 are included in Table 1 below.

TABLE 1

| Wireless signal, including various | Types and classifications of |
|---|---|
| reference signals, e.g., SRS, DMRS, etc. | wireless signals |
| CSI | Properties of a channel on a frequency sub-band |
| Frequency Sub-Bands | List of frequency sub-bands across a full bandwidth |
| Slots | Number and frequency of slots that receive signals |

The one or more training data sets 1010 are used by the AI/ML model 1020 to generate a decision \hat{X}. The decision \hat{X} is compared to the known Genie values X to determine an error. The genie known values X may be a known decision for the training data set 1010. If the error rate is less than a threshold value 1030, the AI/ML model is validated (e.g., tested) using testing data. If the error rate is greater than a threshold value 1030, the AI/ML model 1020 is retrained using the error to adjust one or more parameters of the one or more AI/ML methods. For example, the AI/ML model 1020 for the CSI AI/ML model during the training phase may have as inputs true CSI of frequency sub-bands from previously received signals at various slots, and output the extrapolated CSI of a particular frequency sub-band at a particular slot based on its current model. The same true CSI of frequency sub-bands from previously received signals at various slots may also be obtained from a real-world network or simulated network, and the actual or simulated wireless signal classification may be used as the reference genie data for the AI/ML model training. The decision made by the AI/ML CSI model can be compared to a real world decision to determine an error rate. If the AI/ML CSI model scores beneath an threshold error rate (e.g., the AI/ML CSI model incorrectly predicted the real world decision), then the AI/ML CSI model can be re-trained via a feedback loop 1040.

FIG. 10B is a block diagram of an example process 1050 of validating the AI/ML models 1020 disclosed herein, according to one embodiment. Validating the AI/ML models 1020 includes inputting a testing data set 1060 different from the training data set 1010 into the trained AI/ML model 1070. The testing data set 1060 can include one or more sets of data disclosed in Table 1 as training data. The testing data set 1060 is used by the trained AI/ML model 1070 to generate a decision \hat{X}. The decision \hat{X} is compared the genie known values X to determine an error rate. If the error rate is less than a threshold value 1030, the AI/ML model is deployed. If the error rate is greater than a threshold value 1030, the AI/ML model 1070 is re-trained using additional training data sets 1080. The re-training procedure can mirror the training procedure described in FIG. 10A. For example, if the CSI AI/ML model determines extrapolated CSI of a frequency sub-band that is inaccurate according to a testing data set of the true CSI of the frequency sub-band then the CSI AI/ML model can be re-trained using additional training data.

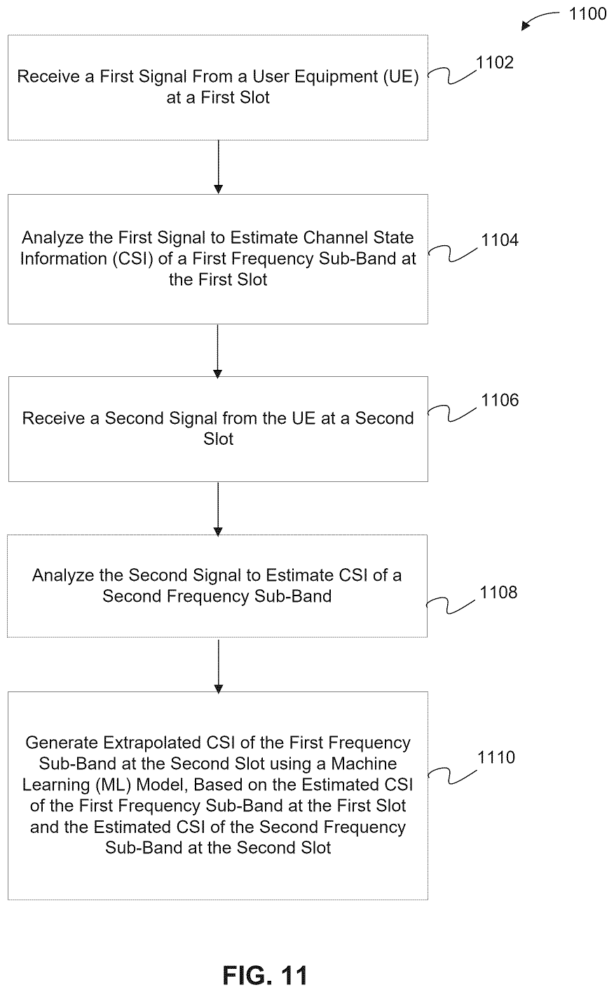

FIG. 11 is an illustration of an example method 1100 of extrapolating and predicting channels of frequency sub-bands using previously received signals from the UE. The method 1100 includes estimating channel state information (CSI) of a first frequency sub-band from a first signal received from a user equipment (UE) at a first slot. The method 1100 includes using a ML model to extrapolate CSI of a second frequency sub-band that is adjacent to the first frequency sub-band, according to the estimated CSI of the first frequency sub-band and other CSI of signals received at previous slots.

At operation 1102, the method 1100 includes receiving a first signal from a user equipment (UE) at a first slot. A base station, such as a gNodeB (gNB), of a wireless network may receive a first wireless signal from a user equipment (UE) at a first slot. The first signal from the UE may be a pilot signal, training sequence, reference signal, sounding reference signal (SRS), or uplink demodulation reference signal (DMRS). The first slot may be at a particular period in time. The first slot may be one of a plurality of slots to receive a signal from the UE, with each slot to receive a SRS signal from the UE occurring at a set time period after the previous slot, such as, for example, every 20 or 40 milliseconds. The gNB may receive SRS signals from the UE sparsely in time.

At operation 1104, the method 1100 includes analyzing the signal to estimate channel state information (CSI) of a first frequency sub-band at the first slot. The first signal received from the UE may be associated with a first frequency sub-band. The first signal may be analyzed to estimate CSI of the first frequency sub-band. The CSI of a frequency sub-band may include properties of a channel on the frequency sub-band. The channel properties may include signal-to-noise-ratio (SNR), signal-to-interference-plus-noise-ratio (SINR), Doppler spread, and delay spread. Each channel characteristic and property may provide knowledge on the UE-gNB link, such as: (i) Doppler, to determine how fast the UE is moving; (ii) delay spread, to determine the coherence bandwidth; (iii) SNR, to determine how strong the signal is from transmitter to receiver; and (iv) power delay profile, to determine channel characteristics (e.g., indoor/outdoor). The CSI of the first frequency sub-band may be similar to the CSI of closely spaced, adjacent frequency sub-bands to the first frequency sub-band.

At operation 1106, the method 1100 includes receiving a second signal from the UE at a second slot. The gNB base station may receive a second wireless signal from the UE at a second slot. The second slot may be at a time period after the first slot. The gNB may have received the second signal from the UE at the second slot for example, 20 milliseconds after the gNB received the first signal from the UE at the first slot. The second signal from the UE may also comprise a pilot signal, training sequence, reference signal, SRS, or DMRS.

At operation 1108, the method 1100 includes analyzing the second signal to estimate CSI of a second frequency sub-band. The gNB may analyze the received second signal from the UE at the second slot to estimate CSI of a second frequency sub-band. The second frequency sub-band may be closely spaced and adjacent to the first frequency sub-band. The estimated CSI of the first frequency sub-band at the first slot and the estimated CSI of the second frequency sub-band at the second slot may be stored in a database, or AI/ML model. The CSI of the second frequency sub-band may be similar to the CSI of closely spaced, adjacent frequency sub-bands to the second frequency sub-band, and to the CSI of the second frequency sub-band in previous and/or future slots.

At operation 1110, the method 1100 includes generating extrapolated CSI of the first frequency sub-band at the second slot using a ML model. With SRS signals from the UE being received sparsely in time, the second signal received from the UE at the second slot may be repurposed and reused to extrapolate CSI of closely spaced, adjacent frequency sub-bands at the same second slot. The first signal received from the UE at the previous, first slot may also be repurposed and reused to extrapolate CSI of the same frequency sub-band at a different slot, such as the second slot. The true CSI (where genie data is available, for example from simulation) of the second frequency sub-band from the second signal at the second slot and the true CSI (where genie data is available, for example from simulation) of the first frequency sub-band from the first signal at the first slot may be used to train a ML model.

Using the true CSI of a frequency sub-band from a signal at a particular slot to train the ML model may allow the ML model to extrapolate and predict CSI of the same frequency sub-band at a different slot. Using the true CSI of a particular frequency sub-band from a signal at a particular slot to train the ML model may allow the ML model to extrapolate and predict CSI of a different frequency sub-band at the same slot, given that the different frequency sub-band is closely spaced and adjacent to the particular frequency sub-band. In this way, the ML model may be trained to extrapolate and predict CSI across time and frequency. Using the extrapolated CSI of the first frequency sub-band at the second slot, the gNB may perform beamforming in the downlink (DL) to the UE.

The gNB may receive a third signal from the UE. The third signal may be analyzed to estimate CSI of the first frequency sub-band at the second slot. The extrapolated CSI generated by the ML model may be analyzed against the estimated CSI of the first frequency sub-band at the second slot. The ML model may be trained with the estimated CSI of the first frequency sub-band at the second slot to improve extrapolation and prediction of CSI of frequency sub-bands across time and frequency.

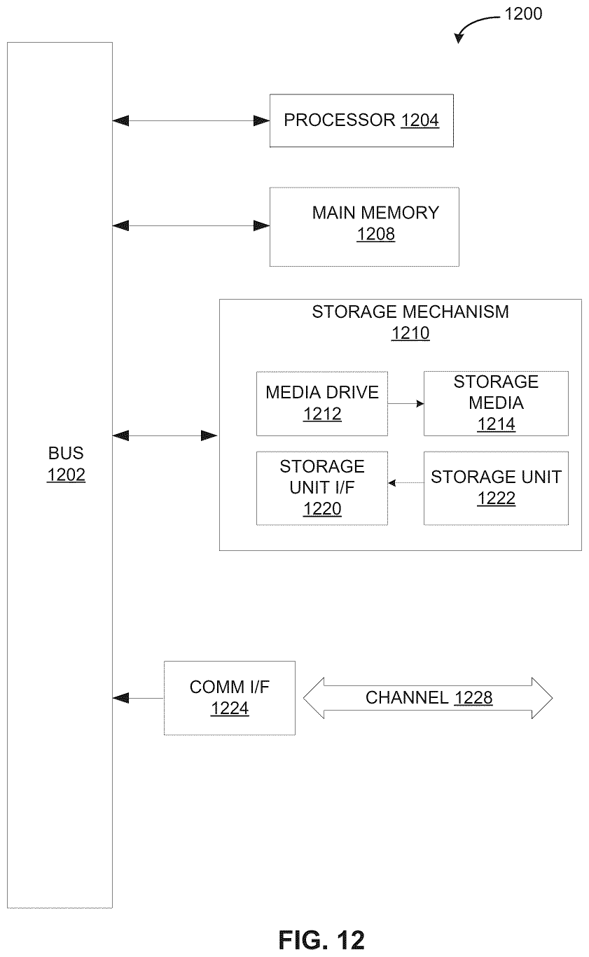

FIG. 12 illustrates an example computing module 1200, an example of which may be a processor/controller resident on a mobile device, or a processor/controller used to operate a wireless communication device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAS, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example-computing module 1200. After reading this description, it will become apparent to a person skilled in the relevant art how to implement the application using other computing modules or architectures.

Referring now to FIG. 12, computing module 1200 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1200 might include, for example, one or more processors, controllers, control modules, or other processing devices, such as a processor 1204. Processor 1204 might be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally. The bus 1202 may also be connected to other components such as a display, input devices, or cursor control to help facilitate interaction and communications between the processor and/or other components of the computing module 1200.

Computing module 1200 might also include one or more memory modules, simply referred to herein as main memory 1208. For example, preferably random-access memory (RAM) or other dynamic memory might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device 1210 coupled to bus 1202 for storing static information and instructions for processor 1204.

Computing module 1200 might also include one or more various forms of information storage devices 1210, which might include, for example, a media drive 1212 and a storage unit interface 1220. The media drive 1212 might include a drive or other mechanism to support fixed or removable storage media 1214. For example, a hard disk drive, a floppy disk drive, a magnetic tape drive, an optical disk drive, a CD, DVD or Bluray drive (R or RW), or other removable or fixed media drive 1212 might be provided. Accordingly, storage media 1214 might include, for example, a hard disk, a floppy disk, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage devices 1210 might include other similar instrumentalities for allowing computer programs or other instructions or data to be loaded into computing module 1200. Such instrumentalities might include, for example, a fixed or removable storage unit 1222 and a storage unit interface 1220. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 1200.

Computing module 1200 might also include a communications interface or network interface(s) 1224. Communications or network interface(s) interface might be used to allow software and data to be transferred between computing module 1200 and external devices. Examples of communications interface or network interface(s) might include a modem or soft modem, a network interface (such as an Ethernet, network interface card, WiMedia, WiFi, IEEE 802.XX or other interface), a communications port (such as, for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 1228. This channel 1228 might carry signals and might be implemented using a wired or wireless communication medium. Some examples of a channel 1228 might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1208, ROM, and storage unit interface 1220. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1200 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGs are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as effective as possible under the given circumstances, or making or achieving performance better than that which can be achieved with other settings or parameters.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
one or more hardware processors; and
one or more non-transitory machine-readable storage media encoded with instructions that, when executed by the one or more hardware processors, cause the system to perform operations comprising:
receiving a first signal from a user equipment (UE) at a first slot;
computing channel state information (CSI) of a first frequency sub-band at the first slot based on the first signal;
receiving a second signal from the UE at a second slot;
computing CSI of a second frequency sub-band at the second slot based on the second signal; and
generating, using a machine learning (ML) model, an extrapolated CSI of the first frequency sub-band at the second slot based on the CSI of the first frequency sub-band at the first slot and the CSI of the second frequency sub-band at the second slot.

2. The system of claim 1, wherein the first signal and the second signal are at least one of a first group comprising a pilot signal, training sequence, reference signal, sounding reference signal (SRS), and uplink demodulation reference signal (DMRS).

3. The system of claim 1, wherein the CSI of the first and the second sub-band comprises properties of a channel on the frequency sub-band that comprise signal-to-noise-ratio (SNR), signal-to-interference-plus-noise-ratio (SINR), Doppler spread, and delay spread.

4. The system of claim 1, wherein the second slot is at a pre-determined time period after the first slot.

5. The system of claim 1, wherein the second frequency sub-band is adjacent to the first frequency sub-band.

6. The system of claim 1, wherein the operations further comprise:
selecting the ML model from a plurality of ML models based on the CSI of the first frequency sub-band at the first slot and the CSI of the second frequency sub-band at the second slot, wherein each of the plurality of ML models is trained for a different range of channel properties, and the channel properties comprise at least one of signal-to-noise ratio (SNR), signal-to-interference-plus-noise ratio (SINR), Doppler spread, or delay spread.

7. The system of claim 6, wherein the selecting the ML model comprises:
determining a set of channel properties based on both the CSI of the first frequency sub-band at the first slot and the CSI of the second frequency sub-band at the second slot;
comparing the determined channel properties to predefined channel condition ranges associated with the plurality of ML models; and
selecting, from the plurality of ML models, the ML model with an associated channel condition range that matches the determined channel properties.

8. The system of claim 1, wherein the ML model is trained to extrapolate CSI of a plurality of frequency sub-bands at a plurality of slots according to estimated CSI determined from signals received from the UE.

9. The system of claim 1, the operations further comprising:
receiving a third signal from the UE;
analyzing the third signal to estimate CSI of the first frequency sub-band at the second slot; and
training the ML model with the extrapolated CSI and the estimated CSI of the first frequency sub-band at the second slot.

10. The system of claim 1, the operations further comprising:
transmitting, via beamforming and using a multiple-input multiple-output (MIMO) technique, a transmission signal to the UE based on the extrapolated CSI of the first frequency sub-band at the second slot.

11. A computer-implemented method, comprising:
receiving, by a computing system, a first signal from a user equipment (UE) at a first slot;
computing, by the computing system, channel state information (CSI) of a first frequency sub-band at the first slot based on the first signal;
receiving, by the computing system, a second signal from the UE at a second slot;
computing, by the computing system, CSI of a second frequency sub-band at the second slot based on the second signal; and
generating, by the computing system and using a machine learning (ML) model, an extrapolated CSI of the first frequency sub-band at the second slot based on the CSI of the first frequency sub-band at the first slot and the CSI of the second frequency sub-band at the second slot.

12. The method of claim 11, wherein the first signal and the second signal comprise at least one of a pilot signal, training sequence, reference signal, sounding reference signal (SRS), or uplink demodulation reference signal (DMRS).

13. The method of claim 11, wherein the CSI of the first and second frequency sub-bands comprises channel properties comprising at least one of signal-to-noise ratio (SNR), signal-to-interference-plus-noise ratio (SINR), Doppler spread, or delay spread.

14. The method of claim 11, wherein the second slot occurs at a predetermined time interval after the first slot.

15. The method of claim 11, further comprising:
selecting the ML model from a plurality of ML models based on the CSI of the first frequency sub-band at the first slot and the CSI of the second frequency sub-band at the second slot, wherein each ML model is trained for a different range of channel properties comprising at least one of SNR, SINR, Doppler spread, or delay spread.

16. The method of claim 15, wherein selecting the ML model comprises:
determining a set of channel properties based on both the CSI of the first frequency sub-band at the first slot and the CSI of the second frequency sub-band at the second slot;
comparing the determined channel properties to predefined channel condition ranges associated with the plurality of ML models; and
selecting, from the plurality of ML models, a model with an associated channel condition range that matches the determined channel properties.

17. The method of claim 11, further comprising:
receiving a third signal from the UE;
analyzing the third signal to estimate CSI of the first frequency sub-band at the second slot; and
training the ML model using the extrapolated CSI and the estimated CSI of the first frequency sub-band at the second slot.

18. The method of claim 11, further comprising:
transmitting, using a multiple-input multiple-output (MIMO) beamforming technique, a signal to the UE based on the extrapolated CSI of the first frequency sub-band at the second slot.

19. A non-transitory computer-readable medium storing instructions that, when executed by one or more processors, cause a computing system to perform operations comprising:
receiving a first signal from a user equipment (UE) at a first slot;
computing channel state information (CSI) of a first frequency sub-band at the first slot based on the first signal;
receiving a second signal from the UE at a second slot;
computing CSI of a second frequency sub-band at the second slot based on the second signal; and
generating, using a machine learning (ML) model, an extrapolated CSI of the first frequency sub-band at the second slot based on the CSI of the first frequency sub-band at the first slot and the CSI of the second frequency sub-band at the second slot.

20. The non-transitory computer-readable medium of claim 19, wherein the operations further comprising:
selecting the ML model from a plurality of ML models based on the CSI of the first frequency sub-band at the first slot and the CSI of the second frequency sub-band at the second slot,
wherein each ML model is trained for a different range of channel properties comprising at least one of signal-to-noise ratio (SNR), signal-to-interference-plus-noise ratio (SINR), Doppler spread, or delay spread.
